(19) United States
(12) Patent Application Publication
(10) Pub. No.: US 2009/0085398 A1
(43) Pub. Date: Apr. 2, 2009

(54) VEHICLE TRACK AND TRACK SYSTEM

(75) Inventor: Hugues MALTAIS, Valcourt (CA)

Correspondence Address: OSLER, HOSKIN & HARCOURT LLP (BRP), 2100 - 1000 DE LA GAUCHETIERE ST. WEST, MONTREAL, QC, H3B4W5, CA

(73) Assignee: BOMBARDIER RECREATIONAL PRODUCTS INC., Valcourt (CA)

(21) Appl. No.: 11/863,456

(22) Filed: Sep. 28, 2007

(51) Int. Cl. B62D 55/24; B62D 55/12

(52) U.S. Cl. 305/178; 305/199

(57) ABSTRACT

A vehicle track has a belt, a plurality of terrain lugs distributed circumferentially about an outer side of the belt, and a plurality of drive lugs distributed circumferentially about an inner side of the belt. A first and a second strip are disposed on the inner side of the belt. The first strip extends along an entire circumference of the inner side of the belt. The first strip is configured for engaging at least one wheel of a track system when the track is in use with the track system. The second strip is laterally spaced from the first strip and extends along an entire circumference of the inner side of the belt. The second strip is configured for engaging at least one other wheel of the track system when the track is in use with the track system. A vehicle track system is also disclosed.

### FIELD OF THE INVENTION

The present invention relates to vehicle tracks and track systems used for driving vehicles.

### BACKGROUND OF THE INVENTION

Tracked vehicles such as snowmobiles drivingly engage the ground through one or more tracks. As shown in FIG. 1, such a track 2 typically has a belt 4 with a plurality of terrain lugs 6 on an outer side thereof and a plurality of drive lugs 8 on an inner side thereof. Occasionally, rods 10 are disposed transversely inside the belt 4 to increase the rigidity of the track 2. The terrain lugs 6 are designed to engage the ground, apply traction, and propel the vehicle.

One or more drive sprockets (not shown), which are operatively connected to an engine of the vehicle, have teeth that engage the drive lugs 8 to drive the track 2. Wheels, such as wheel 12, are typically provided in a track system on the inner side of the belt 4 to help keep the track 2 moving in its desired path. As the track 2 passes under the wheels 12 noise is generated. The wheels 12 apply pressure on the belt 4 causing in to deflect by an amount Al when one of the wheels 12 is in an area free of lugs 6, 8, as shown in FIG. 1. However, when one of the wheels 12 reaches the area of the belt 4 where a terrain lug 6, and a drive lug 8 (and a rod 10) is located, since the belt 4 is much stiffer in that area, the belt cannot deflect as much. This results in the wheel 12 impacting that area of the belt 4 and the impact generates noise. Following the impact, the wheel 12 may also lose contact with the belt 4 and the impact when it makes contact with the belt 4 again also generates noise.

One way to reduce the noise generated in this manner consists in staggering the wheels 12 such that not all of the wheels impact the stiffer areas of the belt 4 at the same time. Although this reduces the amplitude of the noise, it increases the frequency of the noise since more impacts occur.

Therefore, there is a need for a track and a track system that generates less noise in operation.

### SUMMARY OF THE INVENTION

It is an object of the present invention to ameliorate at least some of the inconveniences present in the prior art.

It is also an object of the present invention to provide a track having strips on an inner side of a belt for engaging wheels of a track system.

It is another object of the present invention to provide a track system having a track with strips on an inner side of a belt and wheels engaging the strips.

By adding strips on the inner side of the track for the wheels of the track system to roll over, the thickness of the track where the strips are located is increased. This results in the track deflecting less when one of the wheels is in an area free of lugs than if no strips were provided. The strips also provide cushioning in areas of the belt where a terrain lug, and a drive lug (and a rod) is located. Therefore, the decreased deflection between the lugs and the increased cushioning at the lugs result in a more stable travel of the wheels over the inner side of the track, which in turn reduces the impacts between the wheels and the track, reduces the likelihood of the wheels leaving the track, and therefore reduces the noise generated.

In one aspect, the invention provides a vehicle track having a belt having an inner side and an outer side, a plurality of terrain lugs distributed circumferentially about the outer side of the belt, and a plurality of drive lugs distributed circumferentially about the inner side of the belt. A first strip is disposed on the inner side of the belt. The first strip extends along an entire circumference of the inner side of the belt. The first strip is configured for engaging at least one wheel of a track system when the track is in use with the track system. A second strip is disposed on the inner side of the belt. The second strip is laterally spaced from the first strip and extends along an entire circumference of the inner side of the belt. The second strip is configured for engaging at least one other wheel of the track system when the track is in use with the track system.

In an additional aspect, the belt is a joint-less belt forming a closed-loop.

In a further aspect, the first and second strips have a substantially equal thickness across their entire lengths.

In an additional aspect, the thickness of each of the first and second strips is less than a thickness of the belt.

In a further aspect, the thickness of each of the first and second strips is less than a height of the plurality of drive lugs.

In an additional aspect, the plurality of drive lugs includes: a first set of drive lugs distributed circumferentially and in lateral alignment about the inner side of the belt, and a second set of drive lugs distributed circumferentially and in lateral alignment about the inner side of the belt. The second set of drive lugs is laterally spaced from the first set of drive lugs. The first strip is disposed laterally between the first set of drive lugs and a first lateral edge of the belt. The second strip is disposed laterally between the second set of drive lugs and a second lateral edge of the belt.

In a further aspect, the plurality of drive lugs also includes: a third set of drive lugs distributed circumferentially and in lateral alignment about the inner side of the belt, and a fourth set of drive lugs distributed circumferentially and in lateral alignment about the inner side of the belt. The third set of drive lugs is disposed laterally between the first and second sets of drive lugs. The fourth set of drive lugs is disposed laterally between the second and third sets of drive lugs. The track also has a third strip disposed on the inner side of the belt, and a fourth strip disposed on the inner side of the belt. The third strip extends along an entire circumference of the inner side of the belt laterally between the first and third sets of drive lugs. The fourth strip extends along an entire circumference of the inner side of the belt laterally between the second and fourth sets of drive lugs.

In an additional aspect, the first and second strips are formed integrally with the belt.

In a further aspect, the first and second strips are made of a first material, and the belt is made of a second material. A hardness of the first material is less than a hardness of the second material.

In another aspect, the invention provides a vehicle track system having a vehicle track. The vehicle track includes a belt having an inner side and an outer side, a plurality of terrain lugs distributed circumferentially about the outer side of the belt, and a plurality of drive lugs distributed circumferentially about the inner side of the belt. A first strip is disposed on the inner side of the belt. The first strip extends along an entire circumference of the inner side of the belt. A second strip is disposed on the inner side of the belt. The second strip is laterally spaced from the first strip and extends along an entire circumference of the inner side of the belt. The vehicle track system also has a first wheel engaging the first strip and a second wheel engaging the second strip.

In a further aspect, the belt is a joint-less belt forming a closed-loop.

In an additional aspect, the first and second strips have a substantially equal thickness across their entire lengths.

In a further aspect, the thickness of each of the first and second strips is less than a thickness of the belt.

In an additional aspect, the thickness of each of the first and second strips is less than a height of the plurality of drive lugs.

In a further aspect, the plurality of drive lugs includes: a first set of drive lugs distributed circumferentially and in lateral alignment about the inner side of the belt, and a second set of drive lugs distributed circumferentially and in lateral alignment about the inner side of the belt. The second set of drive lugs is laterally spaced from the first set of drive lugs. The first strip is disposed laterally between the first set of drive lugs and a first lateral edge of the belt. The second strip is disposed laterally between the second set of drive lugs and a second lateral edge of the belt.

In an additional aspect, the plurality of drive lugs also includes: a third set of drive lugs distributed circumferentially and in lateral alignment about the inner side of the belt, and a fourth set of drive lugs distributed circumferentially and in lateral alignment about the inner side of the belt. The third set of drive lugs is disposed laterally between the first and second sets of drive lugs. The fourth set of drive lugs is disposed laterally between the second and third sets of drive lugs. The track system also has a third strip disposed on the inner side of the belt, and a fourth strip disposed on the inner side of the belt. The third strip extends along an entire circumference of the inner side of the belt laterally between the first and third sets of drive lugs. The fourth strip extends along an entire circumference of the inner side of the belt laterally between the second and fourth sets of drive lugs. A third wheel engages the third strip. A fourth wheel engages the fourth strip.

In a further aspect, the first and second strips are formed integrally with the belt.

In an additional aspect, the first and second strips are made of a first material, and the belt is made of a second material. A hardness of the first material is less than a hardness of the second material.

In a further aspect, the track system is in combination with a snowmobile.

In an additional aspect, the track system is in combination with an all-terrain vehicle.

For purposes of this application, the term “belt” refers to a continuous band of flexible material for transmitting motion and power. The term “strip” refers to a piece of material that is narrower than it is long.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic side view of a portion of a prior art vehicle track system;

FIG. 2 is a perspective view, taken from a front, right side, of a snowmobile combined with a track system according to the present invention;

FIG. 3 is a right side view of the track system of the snowmobile of FIG. 2 with the track shown schematically;

FIG. 4 is a perspective view, taken from a front, left side, of an all-terrain vehicle combined with track systems according to the present invention;

FIG. 5 is a perspective view of a portion of a track according to the present invention;

FIG. 6 is a transverse cross-sectional view of the portion of track of FIG. 5;

FIG. 7 is a top view of a portion of a track system including the portion of track of FIG. 5;

FIG. 8 is an end view of the portion of track system of FIG. 7;

FIG. 9 is a schematic side view of the portion of track system of FIG. 7 with features removed for clarity;

FIG. 10 is a schematic illustration of a layering of material for making a track according to the present invention;

FIG. 11 is a schematic end view of moulds for making a track from the materials shown in FIG. 10; and

FIG. 12 is a schematic side view of the cylinder of the moulds of FIG. 11.

### DETAILED DESCRIPTION OF THE PREFERRED EMBODIMENTS

Although the present invention will be described in combination with a snowmobile and an all-terrain vehicle, it should be understood that it could be used with other types of tracked vehicles.

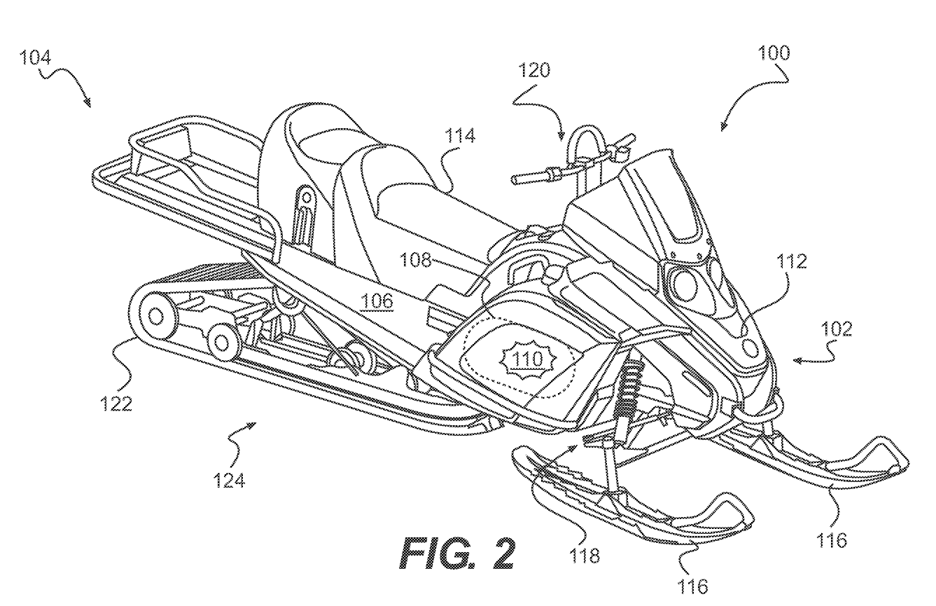

Referring to FIG. 2, a snowmobile 100 has a front end 102 and a rear end 104. The snowmobile 100 has a frame including a tunnel portion 106 and an engine cradle portion 108. An engine 110 (schematically illustrated) is supported by the engine cradle portion 108. A number of fairings 112 are supported on the frame to protect components mounted to the frame and to provide aesthetic appeal. A seat 114 is provided above the tunnel 106 for accommodating a rider and, optionally, one or more passengers.

A pair of skis 116 at the front end 102 of the snowmobile 100 are connected to the frame via a suspension system 118. A steering assembly 120 is provided generally forward of the seat 114, and is connected to the skis 116 in a known manner such that turning the steering assembly 120 turns the skis 116 to steer the snowmobile 100.

At the rear end 104 of the snowmobile 100, a track system 124 including a track 122 is provided. The track 122 is partially disposed in the tunnel portion 106 of the frame, and is driven by the engine 110 via a transmission (not shown) to propel the snowmobile 100.

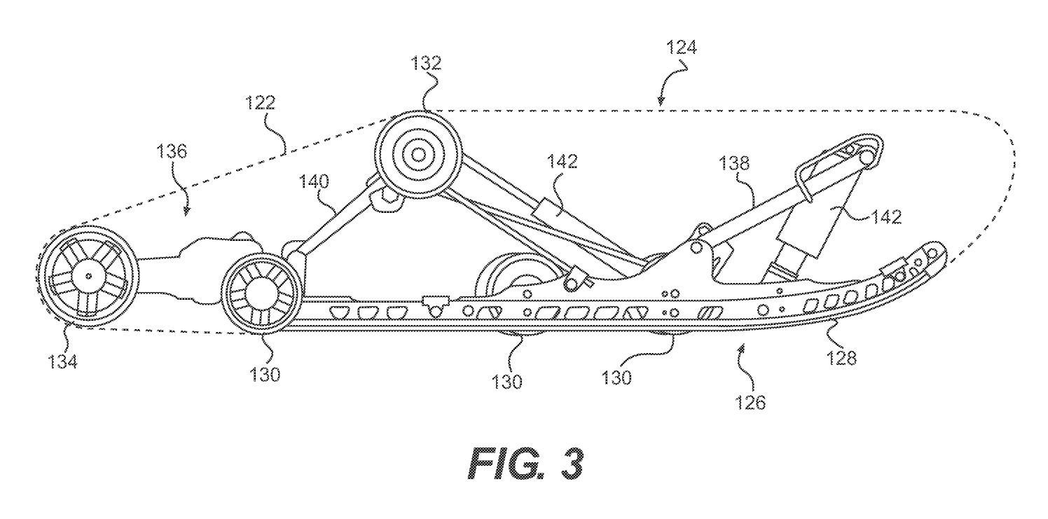

As shown in FIG. 3, the track system 124 includes a slide rail assembly 126. The slide rail assembly 126 includes two parallel slide rails 128 (one on each side) that generally position and guide the track 122 (schematically shown in FIG. 3). The slide rails 128 typically have a curved forward end to follow the track 122 and a flat rear portion to ensure proper traction between the track 122 and the ground. The slide rails 128 typically include a lower sliding surface made of polyethylene to reduce contact friction between the slide rails 128 and the track 122. One or more pairs of lower wheels 130 and one or more pairs of upper wheels 132 engage the track 122 to further guide the track 122. One or more idler wheels 134 are supported on a rail extension assembly 136 to further guide the track 122.

The track system 124 is connected to the tunnel portion 106 via a front suspension arm 138 and a rear suspension arm 140. The front and rear suspension arms 138, 140 are pivotally connected to the tunnel 106 at their upper ends, and pivotally connected to the slide rail assembly 126 at their lower ends. Two shock absorber assemblies 142 bias the slide rail assembly 126 downward against the track 122 to ensure proper contact therebetween. It should be understood that alternative track systems constructed with a single shock absorber assembly 142 or with more than two shock absorber assemblies 142 are contemplated. It is also contemplated that the snowmobile could have two track systems 124 disposed side by side.

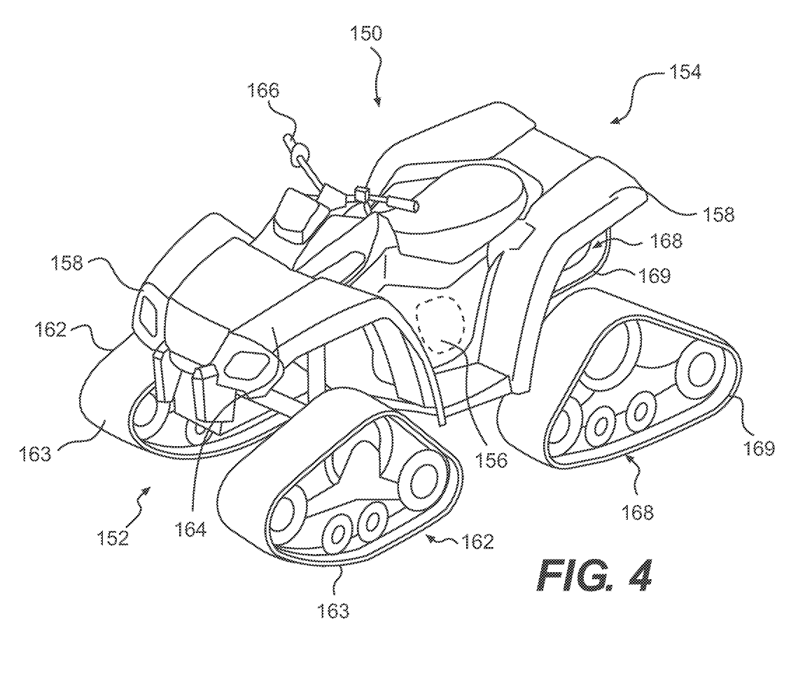

Turning now to FIG. 4, an all-terrain vehicle (ATV) 150 has a front end 152 and a rear end 154. The ATV 150 has a frame (not shown). An engine 156 is supported by the frame. A number of fairings 158 are supported on the frame to protect components mounted to the frame and to provide aesthetic appeal. A seat 160 is provided above the engine 156 for accommodating a rider and, optionally, one or more passengers.

Although ATVs are generally provided with wheels, the ATV 150 has track systems instead. A pair of track systems 162 are provided at the front end 152 of the ATV 150. The track systems 162, including tracks 163, are connected to the frame via a suspension system 164. A steering handlebar 166 is provided generally forward of the seat 160, and is connected to the track systems 162 in a known manner such that turning the steering handlebar 166 turns the track systems 162 to steer the ATV 150. At the rear end 154 of the ATV 150, a pair of track systems 168, including tracks 169, are connected to the frame via a suspension system (not shown). The tracks 163, 169 are driven by the engine 156 via a transmission (not shown) to propel the ATV 150.

The track systems 162 and 168 each include a plurality of wheels therein to engage the tracks 163, 169 respectively to guide the tracks 163, 169. Additional details regarding the construction of an ATV having track systems instead of wheels, such as ATV 150, are described in International Patent Publication number WO 2006/066406 A1, published on Jun. 29, 2006, the entirety of which is incorporated herein by reference. It should be noted that, although the track systems described in this publication can be used for the ATV 150 described herein, that the tracks 163, 169 used in ATV 150 differ from those of the publication as will be described below. It should also be noted that other embodiments of track systems are contemplated.

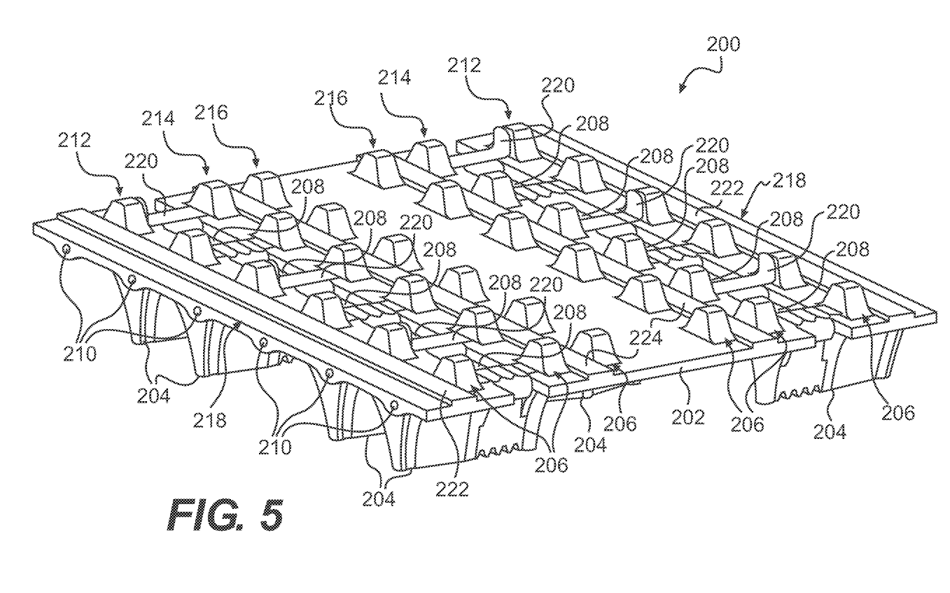

Turning now to FIGS. 5 to 9, a track 200 according to the present invention will be described. It should be understood that track 200 is only an exemplary track and that other embodiments of tracks are contemplated. Some of the contemplated modifications to track 200 will be described below. Track 200 is well suited to be used as track 122 of snowmobile 100 described above. Track 200 can also be used as tracks 163 and 169 of the ATV 150 described above, or could be modified, as would be understood by those skilled in the art, to properly operate in the particular track systems 162 and 168 being used without departing from the scope of the present invention.

Although FIGS. 5 to 9 only show a representative portion of the track 200, it should be understood that track 200 actually forms a closed-loop like in tracks 122, 163, and 169 described above. The track 200 is preferably joint-less and is formed as will be described below in more detail.

Track 200 includes a belt 202. Terrains lugs 204 are disposed circumferentially about the outer side of the belt 202. The terrain lugs 204 provide traction to the track 200. The specific distribution pattern and dimensions of the terrain lugs 204 will vary depending on the application and desired characteristics of the track 200. Drive lugs 206 are disposed circumferentially about the inner side of the belt 202. The drive lugs 206 are configured to be engaged by laterally extending teeth of drive sprockets (not shown) to drive the track 200. Apertures 208 are formed in the belt 202 along the circumference of the belt 202 between drive lugs 206. The apertures 208 are configured to be engaged by radially extending teeth of the drive sprockets to drive the track 200. It is contemplated that the sprockets used could have both laterally and radially extending teeth or only one type of teeth. It is also contemplated that the belt could have no apertures 208. It is further contemplated that only some of the sets of drive lugs 206 (described below) could be engaged by the sprockets and that more or less sets of drive lugs 206 could be used.

A plurality of rods 210, which are preferably made of metal, extend laterally inside the belt 202 at regular intervals. The rods 210 increase the rigidity of the track 200. Each rod 210 is preferably circumferentially aligned with a terrain lug 204, however it is contemplated that more or less rods 210 could be used. It is also contemplated that no rods 210 could be used.

Additional details of the track 200 will now be described. For simplicity only one lateral half of the track 200 will be described. It should be understood that the other half is a mirror image thereof.

There are three sets 212, 214, 216 of drive lugs 206 on each lateral half of the track 200. In each set 212, 214, or 216, the drive lugs 206 are laterally aligned (i.e. in line) and are disposed at regular intervals circumferentially. Preferably, each drive lug 206 of one set 212, 214, or 216 is circumferentially aligned with a drive lug 206 of the two other sets 212, 214, or 216. The outer set 212 is disposed near a lateral edge 218 of the belt 202, the inner set 216 is disposed near a central portion of the belt 202, and the central set 214 is disposed laterally between the inner and outer sets 212, 216.

The apertures 208 are disposed laterally between the outer and central sets 212, 214 of drive lugs 206 and are circumferentially offset from the drive lugs 206 of these sets. Metallic cleats 220 are connected on every second portion of the inner side of the belt 202 located between the apertures 208. It is contemplated that cleats 220 could be connected on every portions of the inner side of the belt 202 located between the apertures 208. It is also contemplated that the cleats 220 could be connected at greater intervals (every third or fourth portion for example). In the case where the track 200 is used with the snowmobile 100 described above, the slide rail 128 slides over the cleats 220 on the portion of the cleats located laterally between the apertures 208 and the outer set 212 of drive lugs 206. The side of slide rail 128 also slides against the vertical portion of the cleats 220 disposed adjacent the outer set 212 of drive lugs. This helps maintain the lateral alignment of the track 202 in the track system 124.

An outer strip 222 of material is disposed on the inner side of the belt 202 laterally between the outer set 212 of drive lugs 206 and the lateral edge 218 of the belt 202. An inner strip 224 of material is disposed on the inner side of the belt 202 laterally between the central set 214 of drive lugs 206 and the inner set 216 of drive lugs 206. The strips 222, 224 each extend along an entire circumference of the inner side of the belt 202 so as to form a closed-loop.

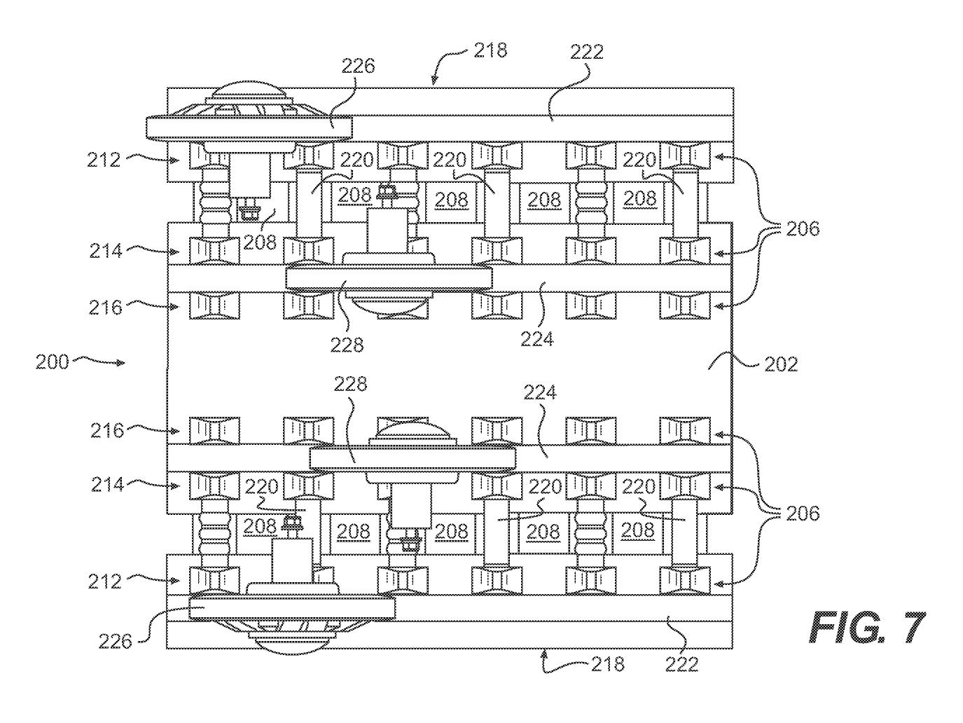

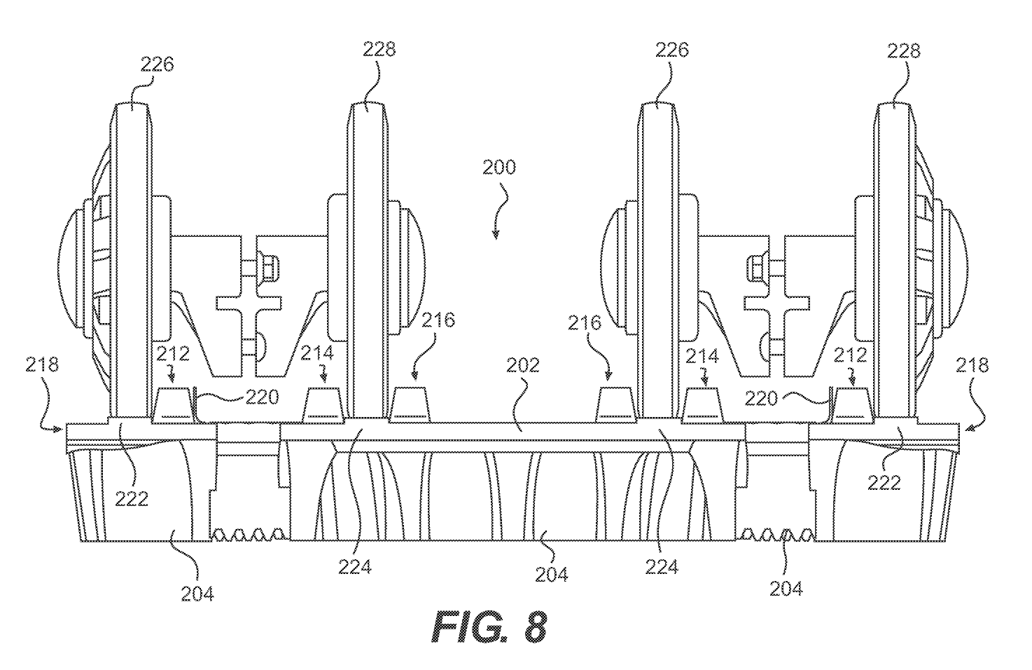

As seen in FIGS. 7 and 8, wheels 226, 228 of a track system including the track 200 engage the strips 222, 224 respectively so as to roll on the strips 222, 224. As seen in FIG. 8, the strips 222, 224 are slightly wider than a contact surface of the wheel 226, 228. It should be understood that although only one wheel 226, 228 is shown as engaging its respective strip 226, 228 that more than one wheel can engage each strip 222, 224. For example, when the track 122 of the track system 124 shown in FIG. 3 has the same construction as track 200, the leftmost (as shown in FIG. 3) lower wheel 130, the idler wheel 134, and the upper wheel 132 engage the outer strip 222, and the central lower wheel 130, and rightmost lower wheel 130 engage the inner strip 224. Although it is preferred that each of the wheels 226, 228 of the track system engage one of the strips 222, 224, it is contemplated that some may not. It is also contemplated that more or less strips could be used depending on the arrangement of the wheels.

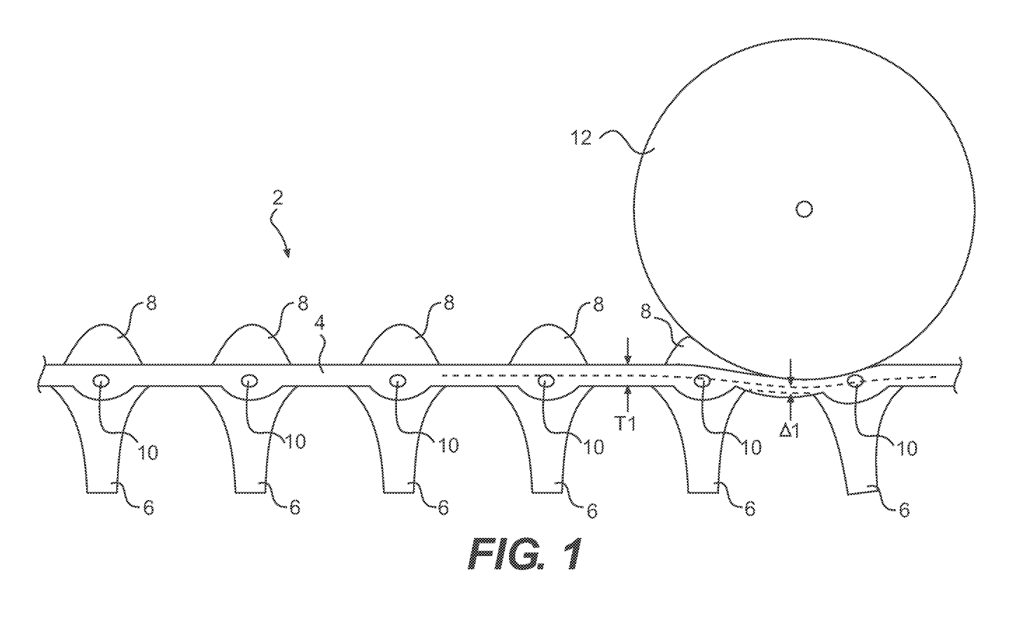

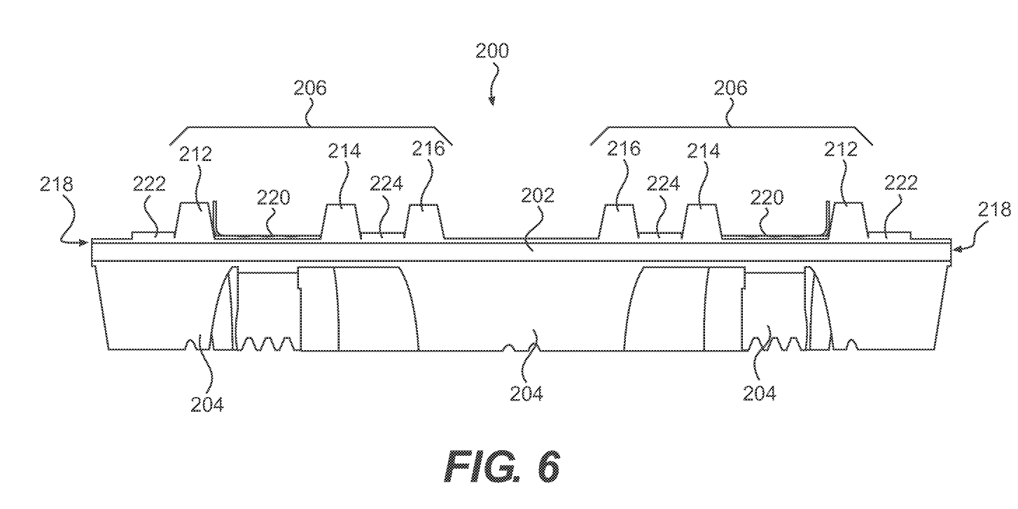

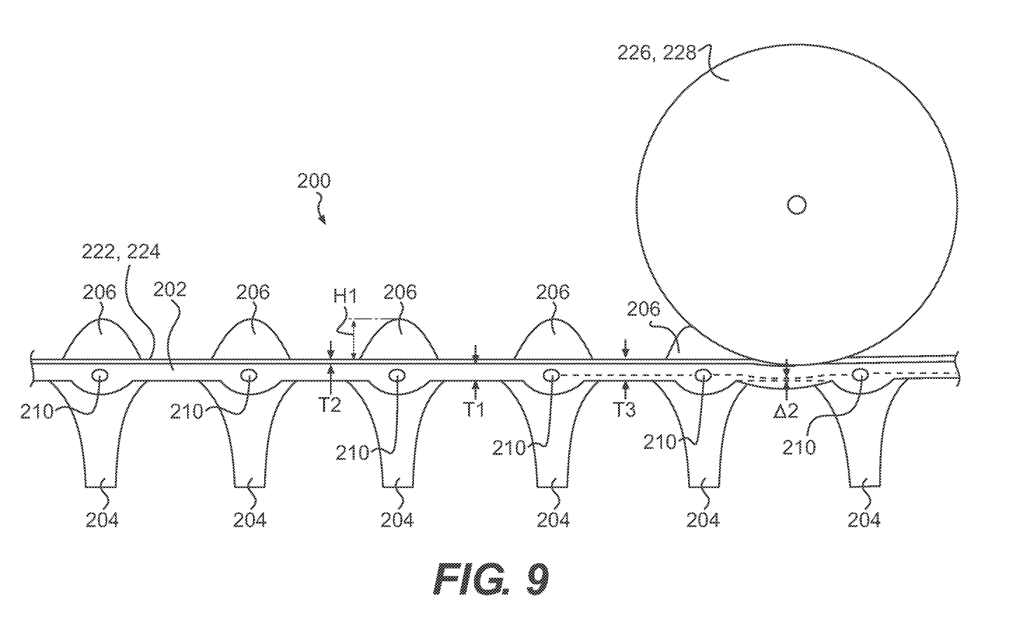

As seen in FIG. 5, the strips 222, 224 have a substantially equal thickness across their entire lengths (in the circumferential direction of belt 202) and have a rectangular cross-section as seen in FIG. 6. It is contemplated that the strips 222, 224 could have other shapes of cross-section, such as, for example, semi-circular or trapezoidal. As seen in FIG. 9, by adding strips 222, 224 of a thickness T2, as measured from the inner side of the belt 202 to the top of the strips 222, 224, to the belt 202 having a thickness T1, the track 202 effectively has a thickness T3 where strips 222, 224 are located. The increased thickness of the track 200 at the location of the strips 222, 224 results in a stiffer track 200 in the portions between the lugs 204, 206. This causes the track 200 to deflect (due to the wheels 226, 228) by an amount Δ2 in these portions of the track 200 that is less than the amount Δ1 by which a track having the same belt thickness T1 but no strips would deflect, such as track 2 of FIG. 1. The strips 222, 224 also provide cushioning for the wheels 226, 228 when they go over the portions of the track 200 having lugs 204, 206 (and rods 210), thus reducing the impact of the wheels 226, 228 with these portions. These combined effects result in a reduction in the noise generated by the track 200 and the wheel 226, 228 when compared with a track having the same general characteristics but not strips.

The thicker the strips 222, 224, the more cushioning and stiffening they will provide, however if the strips 222, 224 are too thick, then the track 200 will become to stiff to easily bend around the track system. As can be seen in FIG. 9, the thickness T2 of the strips 222, 224 is less than a height H1 of the drive lugs 206, as measured from the inner side of the belt 202 to the top of the drive lugs 206. The thickness T2 of the strips 222, 224 is also less than the thickness T1 of the belt 202. For example for a 345.4 cm (136 in.) long track having a belt thickness T1 of approximately 5 mm, the strip thickness T2 is approximately 2 mm. However, it will be understood that the strip thickness T2 best suited for a particular track will depend on the track's length, width, material, belt thickness, terrain and drive lugs patterns and dimensions, the presence or absence of rods, and the characteristics of the track system in which the track will be used.

In order to avoid applying stress on the track 200, it is preferable that the wheels 226, 228 be moved away from the inner surface of the belt 202 by an amount equal to the thickness T2 of the strips 222, 224 relative to their positions if no strips were present (as in FIG. 1).

The belt 202 is preferably joint-less and forms a closed-loop. The belt 202, strips 222, 224, terrain lugs 204, and drive lugs 206 are also preferably integrally formed. However it is contemplated that the strips 222, 224, terrain lugs 204, and drive lugs 206 could be bonded or fastened to the belt 202 is some other way.

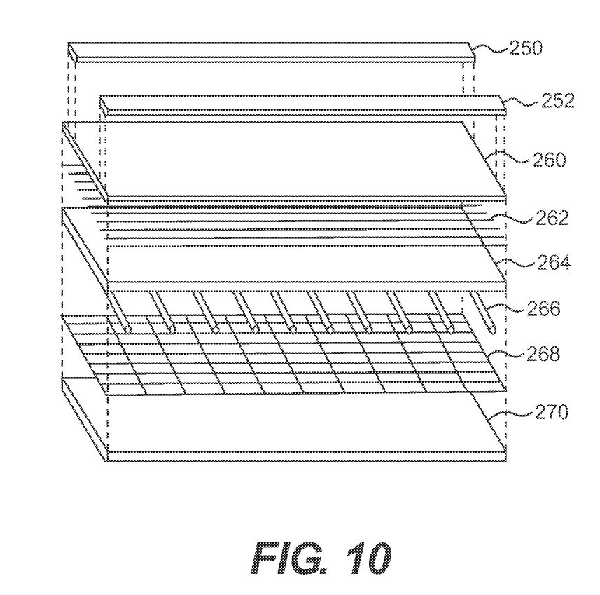

Turning now to FIGS. 10 to 12, an exemplary method of manufacturing a rubber track having a joint-less belt forming a closed-loop and a belt, strips, terrain lugs, and drive lugs that are integrally formed will be described. For simplicity, the track only has two strips 250, 252 and four sets of drive lugs, but it should be understood that the same method could be used for manufacturing the track 200 described above or other tracks having strips for engaging the wheels of a track system.

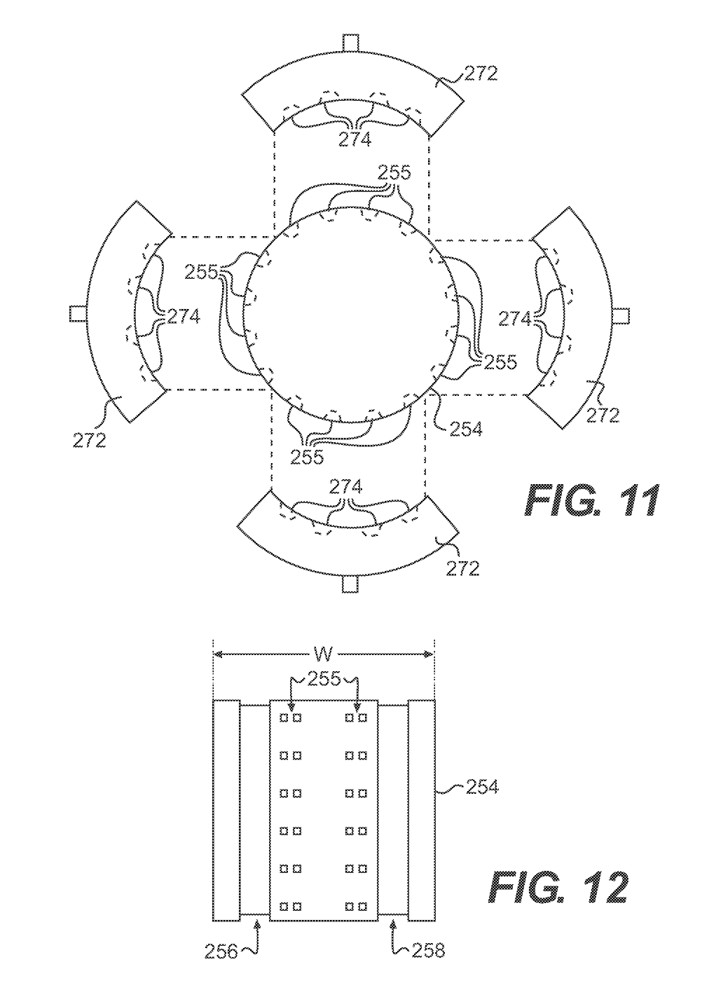

The process begins by placing layers of material (shown in FIG. 10) having substantially the length of the desired track around a cylinder 254 (FIGS. 11, 12). The cylinder 254 has a circumference corresponding to the desired track length, a width W (FIG. 12) corresponding to the desired track width, and a pattern of recesses 255 corresponding to the desired pattern of drive lugs of the finished track. The rubber strips 250, 252 are first placed inside grooves 256, 258 in the cylinder 254. A first layer 260 of rubber is then wrapped around the cylinder 254 and strips 250, 252. A layer of strings 262 is then wrapped around the first layer 260. The layer of strings 262 reinforces the finished track in the circumferential direction. A second layer 264 of rubber is then wrapped around the layer of strings 262. In the case where the finished track should have metallic rods laterally disposed in the belt of the track to increased the rigidity of the track, metallic rods 266 are then placed circumferentially around the second layer 264 of rubber 264. A layer of mesh fabric 268 is then wrapped around the metallic rods 266 or the second layer 264 of rubber as the case may be. The layer of mesh fabric 268 reinforces the finished track in the directions resulting from the mesh pattern as would be understood by those skilled in the art. A third layer 270 of rubber is finally wrapped around the layer of mesh fabric 268. It should be understood that more or less layers could be used and that other types of layers could be used.

Once all the layers of material have been wrapped around the cylinder 254, hydraulically actuated moulds 272 are pressed against the layers and the cylinder 254. The moulds 272 each include a portion of a pattern of recesses 274 corresponding to the desired pattern of terrain lugs of the finished track. The moulds 272, layers of material, and cylinder 254 are then heated in an oven. The heat causes the rubber to melt. The pressure applied by the moulds 272 causes the melted rubber to flow inside the patterns of recesses 255 and 274. The strips 250, 252 and the various layers 260, 264, 270 of rubber are thus joined together and trap the layers of strings, rods, and mesh fabric 262, 266, 268 respectively therein, thereby forming the track. The presence of vulcanizing agents in this process will also increase the strength and resiliency of the rubber. The moulds 272, track, and cylinder 254 are then allowed to cool down before removing the finished track. Should it be desired that the finished track have apertures like apertures 208 of the track 200 described above, the apertures would be cut in the track once the track has cooled down.

The above method allows the manufacturing of a track where the type of rubber used for the strips is different from the type of rubber used for the rest of the track. More specifically, the first and second layers 260, 264 are made of a first type of rubber having a hardness of 70 durometers (on durometer scale A) for example. The strips 250, 252 are made of a second type of softer rubber (60 durometers for example) to provide the cushioning for the wheels. The third layer 270 of rubber is made of a third type of harder rubber (80 durometers for example) since this is the layer forming the terrain lugs that will contact the ground and therefore need to be more resistant. It is contemplated that the first and second layers 260, 264 of rubber could also be made of different types of rubbers. It is also contemplated that all of the layers of rubber could be made of the same type of rubber.

In cases where it is desired that the strips of the track be made of the same material as the first layer 260 of rubber, it is not necessary to first place strips 250, 252 of rubber inside the grooves 256, 258 of the cylinder 254 as described above. Instead, it is contemplated that when the first layer 260 of rubber melts in the oven, that the melted rubber from this layer could be caused to flow inside the grooves 256, 258 due to the pressure applied by the moulds 272, thereby forming the strips, in the same way as the melted rubber is caused to flow into the pattern of recesses 255 to form the drive lugs.

It should be understood that the above method is only one possible way of manufacturing a track. It should be understood that other methods could be used which use different processes.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. A vehicle track comprising:
a belt having an inner side and an outer side;
a plurality of terrain lugs distributed circumferentially about the outer side of the belt;
a plurality of drive lugs distributed circumferentially about the inner side of the belt;
a first strip disposed on the inner side of the belt, the first strip extending along an entire circumference of the inner side of the belt, the first strip being configured for engaging at least one wheel of a track system when the track is in use with the track system; and
a second strip disposed on the inner side of the belt, the second strip being laterally spaced from the first strip and extending along an entire circumference of the inner side of the belt, the second strip being configured for engaging at least one other wheel of the track system when the track is in use with the track system.

2. The vehicle track of claim 1, wherein the belt is a joint-less belt forming a closed-loop.

3. The vehicle track of claim 2, wherein the first and second strips have a substantially equal thickness across their entire lengths.

4. The vehicle track of claim 3, wherein the thickness of each of the first and second strips is less than a thickness of the belt.

5. The vehicle track of claim 3, wherein the thickness of each of the first and second strips is less than a height of the plurality of drive lugs.

6. The vehicle track of claim 2, wherein the plurality of drive lugs includes:
a first set of drive lugs distributed circumferentially and in lateral alignment about the inner side of the belt; and
a second set of drive lugs distributed circumferentially and in lateral alignment about the inner side of the belt, the second set of drive lugs being laterally spaced from the first set of drive lugs;
wherein the first strip is disposed laterally between the first set of drive lugs and a first lateral edge of the belt; and
wherein the second strip is disposed laterally between the second set of drive lugs and a second lateral edge of the belt.

7. The vehicle track of claim 6, wherein the plurality of drive lugs further includes:
a third set of drive lugs distributed circumferentially and in lateral alignment about the inner side of the belt, the third set of drive lugs being disposed laterally between the first and second sets of drive lugs; and
a fourth set of drive lugs distributed circumferentially and in lateral alignment about the inner side of the belt, the fourth set of drive lugs being disposed laterally between the second and third sets of drive lugs; and
the track further comprises:
a third strip disposed on the inner side of the belt, the third strip extending along an entire circumference of the inner side of the belt laterally between the first and third sets of drive lugs; and
a fourth strip disposed on the inner side of the belt, the fourth strip extending along an entire circumference of the inner side of the belt laterally between the second and fourth sets of drive lugs.

8. The vehicle track of claim 2, wherein the first and second strips are formed integrally with the belt.

9. The vehicle track of claim 2, wherein the first and second strips are made of a first material, and the belt is made of a second material; and
wherein a hardness of the first material is less than a hardness of the second material.

10. A vehicle track system comprising:
a vehicle track including:
a belt having an inner side and an outer side;
a plurality of terrain lugs distributed circumferentially about the outer side of the belt;
a plurality of drive lugs distributed circumferentially about the inner side of the belt;
a first strip disposed on the inner side of the belt, the first strip extending along an entire circumference of the inner side of the belt; and
a second strip disposed on the inner side of the belt, the second strip being laterally spaced from the first strip and extending along an entire circumference of the inner side of the belt;
a first wheel engaging the first strip; and
a second wheel engaging the second strip.

11. The vehicle track system of claim 10, wherein the belt is a joint-less belt forming a closed-loop.

12. The vehicle track system of claim 11, wherein the first and second strips have a substantially equal thickness across their entire lengths.

13. The vehicle track system of claim 12, wherein the thickness of each of the first and second strips is less than a thickness of the belt.

14. The vehicle track system of claim 12, wherein the thickness of each of the first and second strips is less than a height of the plurality of drive lugs.

15. The vehicle track system of claim 11, wherein the plurality of drive lugs includes:
a first set of drive lugs distributed circumferentially and in lateral alignment about the inner side of the belt; and
a second set of drive lugs distributed circumferentially and in lateral alignment about the inner side of the belt, the second set of drive lugs being laterally spaced from the first set of drive lugs;
wherein the first strip is disposed laterally between the first set of drive lugs and a first lateral edge of the belt; and
wherein the second strip is disposed laterally between the second set of drive lugs and a second lateral edge of the belt.

16. The vehicle track system of claim 15, wherein the plurality of drive lugs further includes:
a third set of drive lugs distributed circumferentially and in lateral alignment about the inner side of the belt, the third set of drive lugs being disposed laterally between the first and second sets of drive lugs; and
a fourth set of drive lugs distributed circumferentially and in lateral alignment about the inner side of the belt, the fourth set of drive lugs being disposed laterally between the second and third sets of drive lugs; and
the track system further comprises:
a third strip disposed on the inner side of the belt, the third strip extending along an entire circumference of the inner side of the belt laterally between the first and third sets of drive lugs;
a fourth strip disposed on the inner side of the belt, the fourth strip extending along an entire circumference of the inner side of the belt laterally between the second and fourth sets of drive lugs;
a third wheel engaging the third strip; and
a fourth wheel engaging the fourth strip.

17. The vehicle track system of claim 11, wherein the first and second strips are formed integrally with the belt.

18. The vehicle track system of claim 11, wherein the first and second strips are made of a first material, and the belt is made of a second material; and
wherein a hardness of the first material is less than a hardness of the second material.

19. The vehicle track system of claim 11, in combination with a snowmobile.

20. The vehicle track system of claim 11, in combination with an all-terrain vehicle.
